(19) United States
(12) Patent Application Publication
(10) Pub. No.: US 2005/0049357 A1
(43) Pub. Date: Mar. 3, 2005

(54) Thin bond-line silicone adhesive

(76) Inventors: Hong Zhong, Niskayuna, NY (US); Jennifer Lynn David, Ballston Spa, NY (US)

Correspondence Address: Raymond E. Farrell, Esq.;Carter, DeLuca, Farrell & Schmidt, LLP, Suite 225, 445 Broad Hollow Road, Melville, NY, 11747, US

(21) Appl. No.: 10/924,374

(22) Filed: Aug. 23, 2004

Related U.S. Application Data
(63) Continuation-in-part of application No. 10/647,680, filed on Aug. 25, 2003.

(51) Int. Cl. C08L 83/00

(52) U.S. Cl. 524/588

(57) ABSTRACT

Thermal interface compositions contain filler particles possessing a maximum particle size less than 25 microns in diameter blended with a polymer matrix. Such compositions enable lower attainable bond line thickness, which decreases in-situ thermal resistances that exist between thermal interface materials and the corresponding mating surfaces.

This application is a continuation-in-part of U.S. patent application Ser. No. 10/647,680, filed on Aug. 25, 2003, the disclosure of which is hereby incorporated by reference herein.

### BACKGROUND OF THE INVENTION

The present disclosure relates to the composition and preparation of thermally conductive composites containing fillers with a maximum particle diameter of less than 25 microns to reduce bond line thickness, decrease in-situ thermal resistance and improve in-situ heat transfer of thermal interface materials made from such compositions.

Many electrical components generate heat during periods of operation. As electronic devices become denser and more highly integrated, the heat flux increases exponentially. At the same time, because of performance and reliability considerations, the devices need to operate at lower temperatures, thus reducing the temperature difference between the heat generating part of the device and the ambient temperature, which decreases the thermodynamic driving force for heat removal. The increased heat flux and reduced thermodynamic driving force thus require increasingly sophisticated thermal management techniques to facilitate heat removal during periods of operation.

Thermal management techniques often involve the use of some form of heat dissipating unit (which includes, but is not limited to, heat spreader, heat sink, lid, heat pipe, or any other designs and constructions known to those skilled in the art) to conduct heat away from high temperature areas in an electrical system. A heat dissipating unit is a structure formed from a high thermal conductivity material (e.g., copper, aluminum, silicon carbide, metal alloys, polymer composites and ceramic composites) that is mechanically coupled to a heat generating unit to aid in heat removal. In a relatively simple form, a dissipating unit can include a piece of metal (e.g., aluminum or copper) that is in contact with the heat generating unit. Heat from the heat generating unit flows into the heat dissipating unit through the mechanical interface between the units.

In a typical electronic package, a heat dissipating unit is mechanically coupled to the heat producing component during operation by positioning a flat surface of the heat dissipating unit against a flat surface of the heat generating component and holding the heat dissipating unit in place using some form of adhesive or fastener. As can be appreciated, the surface of the heat dissipating unit and the surface of the heat generating component will rarely be perfectly planar or smooth, so air gaps will generally exist between the surfaces. As is generally well known, the existence of air gaps between two opposing surfaces reduces the ability to transfer heat through the interface between the surfaces. Thus, these air gaps reduce the effectiveness and value of the heat dissipating unit as a thermal management device. To address this problem, polymeric compositions have been developed for placement between the heat transfer surfaces to decrease the thermal resistance therebetween.

In general, a heat dissipating unit is attached to the heat generating component via a thin-layer of thermal interface material (TIM). This material is typically a filled polymer system. The effectiveness of heat removal from the device depends on the in-situ thermal resistance of the TIM material which, in turn, depends not only on the bulk thermal conductivities of the TIM material, but also the attainable bond line thickness under industrially relevant pressure and the interfacial resistance. The minimum thickness of the TIM is determined by the degree of surface planarity and roughness of both the heat generating and the heat dissipating units, or the maximum (agglomerated) filler size, whichever is larger. However, this minimum bondline may not be always attainable, especially with highly viscous and thixotropic formulations, under industrially relevant pressure, typically below 250 psi, and more typically at or below 100 psi. In addition, a formulation's viscosity, wettability to the surface, film forming capability and storage stability can greatly affect interfacial resistance and thus the thermal interface material's in-device heat transfer capability.

In many TIM applications the TIM must be sufficiently compliant to provide mechanical isolation of the heat generating component and the heat dissipating unit in those cases where the Coefficient of Thermal Expansion (CTE) of the heat generating component is significantly different (higher or lower) than that of the heat dissipating unit. In such applications, TIM materials have to not only provide an efficient heat transfer pathway but also maintain structural integrity for the whole package or device. They have therefore to maintain satisfactory mechanical as well as thermal properties throughout the lifetime of the device.

A need therefore exists for improved compositions to effectively transfer heat between a heat dissipating unit and a heat producing component while maintaining mechanical integrity throughout the device lifetime.

### BRIEF DESCRIPTION OF THE INVENTION

Thermal interface compositions in accordance with this disclosure are polymeric composites containing filler particles selected from the group consisting of metals, metal oxides, metal nitrides, and combinations thereof, that are 25 microns or less in diameter. The thermal interface compositions have a bond line thickness of from about 0.01 mil to about 5 mil. Thermal resistance can be minimized with a low viscosity formulation that demonstrates a low bond line thickness, good wettability to the substrates to be bonded and good film forming ability. The viscosity of the formulation can be affected by the processing conditions, which include, but are not limited to, order of addition, mixing speed and time, temperature, humidity, vacuum level and filler treatment procedures. In addition, the thermal resistance of the heat generating and/or heat dissipating system is minimized due to the smaller particle sizes that address interfacial contact resistances.

Electrical components are also described herein which include a heat producing component and a heat dissipating unit each in contact with a thermal interface composition of the present disclosure.

Methods of increasing the efficiency of heat transfer in accordance with this disclosure include the steps of interposing a thermal interface composition between a heat producing component and a heat dissipating unit.

### BRIEF DESCRIPTION OF THE DRAWINGS

FIG. 1 is a schematic representation of an electrical component in accordance with this disclosure.

FIG. 2 is a schematic representation of a testing sample including compositions in accordance with this disclosure placed between two coupons, which may be metal-metal, metal-silicon or silicon-silicon.

FIG. 3 is a schematic representation of a die shear setup used to measure adhesion strength of compositions in accordance with this disclosure.

### DETAILED DESCRIPTION OF THE INVENTION

The composition of the present disclosure is a matrix containing filler particles below 25 microns in size. These composites can achieve lower attainable bond line thicknesses from about 0.01 mil to about 5 mil, which allows a lower attainable in-situ thermal resistance. The composition of the present disclosure is especially useful as a thermal interface material between two or more substrates to aid in heat removal from a heat source or a heat generating device.

The matrix can be any polymeric material. Suitable organic matrices include, but are not limited to, polydimethylsiloxane resins, epoxy resins, acrylate resins, other organo-functionalized polysiloxane resins, polyimide resins, fluorocarbon resins, benzocyclobutene resins, fluorinated polyallyl ethers, polyamide resins, polyimidoamide resins, phenol resol resins, aromatic polyester resins, polyphenylene ether (PPE) resins, bismaleimide triazine resins, fluororesins, mixtures thereof and any other polymeric systems known to those skilled in the art. (For common polymers, see “Polymer Handbook:, Branduf, J.,; Immergut, E. H; Grulke, Eric A; Wiley Interscience Publication, New York, 4^{th} ed.(1999); “Polymer Data Handbook Mark, James Oxford University Press, New York (1999)). Preferred curable thermoset matrices are acrylate resins, epoxy resins, polydimethyl siloxane resins, other organo-functionalized polysiloxane resins that can form cross-linking networks via free radical polymerization, atom transfer, radical polymerization ring-opening polymerization, ring-opening metathesis polymerization, anionic polymerization, cationic polymerization or any other method known to those skilled in the art, and mixtures thereof. Suitable curable silicone resins include, for example, the addition curable and condensation curable matrices as described in “Chemistry and Technology of Silicone”, Noll, W.; Academic Press 1968. Where the polymer matrix is not a curable polymer, the resulting thermal interface composition can be formulated as a gel, grease or phase change materials that can hold components together during fabrication and thermal transfer during operation of the device.

In another embodiment, the polymeric matrix can be an organic-inorganic hybrid matrix. Hybrid matrices include any polymers that contain chemically bound main group metal elements (e.g., aluminum, magnesium, gallium, indium), main group semi-metal elements (e.g. boron, germanium, arsenic, antimony), phosphorous, selenium, transition metal elements (e.g., platinum, palladium, gold, silver, copper, zinc, zirconium, titanium, ruthenium, lanthanum, etc.) or inorganic clusters (which include, but are not limited to, polyhedral oligomeric silsesquioxanes, nano metal oxides, nano silicon oxides, nano metal particles coated with metal oxides, and nano metal particles.) For typical examples and methods of forming inorganic-organic hybrids, see reviews such as “Hybrid Organic Inorganic Materials—in Search of Synergic Activity” by Pedro Gomez-Romero, Advanced Materials, 2001, Vol. 13, No. 3, pp. 163-174; “Inorganic Clusters in Organic Polymers and the Use of Polyfunctional Inorganic Compounds as Polymerization Initiators” by Guido Kickelbick and Ulrich Schubert, Monatshefte fur Chemie, 2001, Vol. 132, pp. 13-30; “Synthesis and Application of Inorganic/Organic Composite Materials”, by Helmut Schmidt, Macromolecular Symposia, 1996, Vol. 101, pp. 333-342; and “Synthesis of Nanocomposite Organic/Inorganic Hybrid Materials Using Controlled/‘Living’ Radical Polymerization” by Jeffrey Pyun and Krzysztof Matyjaszewski, Chemistry of Materials, 2001, Vol. 13, pp. 3436-3448. As used herein, “chemically bound” refers to bonding through a covalent bond, an ionic interaction, an iono-covalent bond, a dative bond or a hydrogen bond. Organic-inorganic hybrid polymeric matrices may refer to, but are not limited to, copolymerization products between organic monomers, oligomers or polymers that contain polymerizable groups such as alkenyl, allyl, Si—H, acrylate, methacrylate, styrenic, isocyanate, epoxide and other common groups known to those skilled in the art, and inorganic clusters or organometallic compounds containing polymerizable groups. For example, the copolymerization product between an acrylate or a methacrylate and a metal acrylate or methacrylate compound is an organic-inorganic hybrid polymeric matrix. The copolymerization product between an epoxide and an epoxide-functionalized inorganic cluster is also considered an inorganic-organic hybrid polymer. The homo-polymerization products of organo-functionalized inorganic clusters or organometallic compounds, or the copolymerization products among different organo-functionalized inorganic clusters or organometallic compounds, are also considered organic-inorganic hybrid matrices. Organic-inorganic hybrid matrices also include cases where the inorganic cluster or organometallic compound has no polymerizable functional groups, but can become part of the polymer network through its surface OH or other functional groups.

In a preferred embodiment, the matrix is an addition curable silicone rubber composition including the following components:
(A) 100 parts by weight of an organopolysiloxane containing an average of at least two silicon-bonded alkenyl groups per molecule;
(B) 0.1-50 parts by weight of an organohydrogenpolysiloxane containing an average of at least two silicon-bonded hydrogen atoms per molecule;
(C) a hydrosilylation catalyst; and optionally
(D) catalyst inhibtor(s); and
(E) adhesion promoters.

Where utilized, the organopolysiloxane (component A) contains an average of at least two alkenyl groups bonded with silicon atoms per molecule. The alkenyl groups that are bonded with silicon atoms include, for example, vinyl groups, allyl groups, butenyl groups, pentenyl groups, hexenyl groups and heptenyl groups. Of these, vinyl groups are particularly preferred. The bonding positions of the alkenyl groups in the organopolysiloxane include, for example, the terminals of the molecular chain and/or side chains of the molecular chain. Organic groups that are bonded with the silicon atoms in addition to the alkenyl groups of the organopolysiloxane include, for example, alkyl groups such as methyl groups, ethyl groups, propyl groups, butyl groups, pentyl groups, hexyl groups and heptyl groups, aryl groups such as phenyl groups, tolyl groups, xylyl groups and naphthyl groups, aralkyl groups such as benzyl groups and phenethyl groups and halogenated groups such as chloromethyl groups, 3-chloropropyl groups and 3,3,3-trifluoropropyl groups, with methyl groups and phenyl groups being particularly preferred. The molecular structure of the organopolysiloxane can be, for example, in straight chain form, a straight chain form having some branches, in cyclic form and in branched chain form, with the straight chain form being particularly desirable. Although there is no limitation on the viscosity of the organopolysiloxane, a viscosity in the range of about 10 to about 500,000 centipoise at 25° C. is preferred, with a range of about 50 to about 5,000 centipoise being particularly preferred.

The organopolysiloxane (component A) can include, for example, copolymers of dimethyl siloxane blocked with trimethylsiloxy groups at both terminals of the molecular chain and of methyl vinyl siloxane; methyl vinyl polysiloxane blocked with trimethylsiloxy groups at both terminals of the molecular chain; copolymers of dimethyl siloxane blocked with trimethylsiloxy groups at both terminals of the molecular chain, methyl vinyl siloxane and methyl phenyl siloxane; dimethyl polysiloxane blocked with dimethylvinyl siloxane groups at both terminals of the molecular chain; methyl vinyl polysiloxane blocked with dimethyl vinyl siloxane groups at both terminals of the molecular chain; copolymers of dimethyl siloxane blocked with dimethyl vinyl siloxane groups at both terminals of the molecular chain and of methyl vinyl siloxane; copolymers of dimethyl siloxane blocked with dimethyl vinyl siloxane groups at both terminals of the molecular chain, methyl vinyl siloxane and methyl phenyl siloxane; organopolysiloxane copolymers comprised of siloxane units as indicated by the formula R¹₃SiO_{1/2}, siloxane units as indicated by the formula R¹₂R²SiO_{1/2}, as indicated by the formula R¹₂SiO_{2/2} and a small quantity of siloxane units as indicated by the formula SiO_{4/2}; organopolysiloxane copolymers comprised of siloxane units as indicated by the formula R¹₂R²SiO_{1/2}, siloxane units as indicated by the formula R¹₂SiO_{2/2} and siloxane units as indicated by the formula SiO_{4/2}; organopolysiloxane copolymers comprised of siloxane units as indicated by the formula R¹R²SiO_{2/2}, siloxane units as indicated by the formula R¹SiO_{3/2} and siloxane units as indicated by the formula R²SiO_{3/2}, and mixtures of two or more of these organopolysiloxanes. In the foregoing formulas, R¹ is a monovalent hydrocarbon group other than an alkenyl group, for example, an alkyl group such as a methyl group, an ethyl group, a propyl group, a butyl group, a pentyl group, a hexyl group or a heptyl group, an aryl group such as a phenyl group, a tolyl group, a xylyl group or a naphthyl group, an aralkyl group such as a phenethyl group or a halogenated alkyl group such as a chloromethyl group, a 3-chloropropyl group or a 3,3,3-trifluoropropyl group. In the foregoing formulas, R² is an alkenyl group, for example, a vinyl group, an allyl group, a butenyl group, a pentenyl group, a hexenyl group or a heptenyl group.

Where utilized, the organohydrogenpolysiloxane acts as a crosslinking agent and contains an average of at least two hydrogen atoms that are bonded to silicon atoms per molecule. The positions of bonding of the hydrogen atoms bonded with the silicon atoms in the organohydrogenpolysiloxane can be, for example, the terminals of the molecular chain and/or side chains of the molecular chain. Organic groups bonded with silicon atoms of the organohydrogenpolysiloxane include, for example, alkyl groups such as methyl groups, ethyl groups, propyl groups, butyl groups, pentyl groups, hexyl groups and heptyl groups, aryl groups such as phenyl groups, tolyl groups, xylyl groups and naphthyl groups, aralkyl groups such as phenethyl groups or halogenated alkyl groups such as chloromethyl groups, 3-chloropropyl groups or 3,3,3-trifluoropropyl groups. Methyl groups and phenyl groups are particular preferred. The molecular structure of the organohydrogenpolysiloxane may be, for example, in straight chain form, a straight chain form having some branches, in cyclic form and in branched chain form, with the straight chain form being particularly preferred. Although there is no limitation on the viscosity of the organohydrogenpolysiloxane, a viscosity in the range of about 1 to about 500,000 centipoise at 25° C. is desirable, with a range of about 5 to about 5,000 centipoise being particularly preferred.

The organohydrogenpolysiloxane (component B) can include, for example, methylhydrogen polysiloxane blocked with trimethylsiloxy groups at both terminals of the molecular chain, copolymers of dimethyl siloxane blocked with trimethylsiloxy groups at both terminals of the molecular chain and of methylhydrogen siloxane, copolymers of dimethyl siloxane blocked with trimethylsiloxy groups at both terminals of the molecular chain, methylhydrogen siloxane and methylphenyl siloxane, dimethyl polysiloxane blocked with dimethylhydrogen siloxane groups at both terminals of the molecular chain, dimethyl polysiloxane blocked with dimethylhydrogen siloxane groups at both terminals of the molecular chain, copolymers of dimethyl blocked with dimethylhydrogen siloxane groups at both terminals of the molecular chain and methylphenyl siloxane, methylphenyl polysiloxane blocked with dimethylhydrogen siloxane groups at both terminals of the molecular chain, organopolysiloxane copolymers comprised of siloxane units as indicated by the formula R¹₃SiO_{1/2} siloxane units as indicated by the formula R¹₂HSiO_{1/2} and siloxane units as indicated by the formula SiO_{4/2}, organopolysiloxane copolymers comprised of siloxane units as indicated by the formula R¹₂HSiO_{1/2} and siloxane units as indicated by the formula SiO_{4/2}, organopolysiloxane copolymers comprised of siloxane units as indicated by the formula R¹HSiO_{2/2}, siloxane units as indicated by the formula R¹SiO_{3/2} and siloxane units as indicated by the formula HSiO_{3/2}, and mixtures of two or more of these organopolysiloxanes. In the foregoing formulas R¹ is a monovalent hydrocarbon group other than an alkenyl group, for example, an alkyl group such as a methyl group, an ethyl group, a propyl group, a butyl group, a pentyl group, a hexyl group or a heptyl group, an aryl group such as a phenyl group, a tolyl group, a xylyl group or a naphthyl group, an aralkyl group such as a benzyl group or a phenethyl group or a halogenated alkyl group such as a chloromethyl group, a 3-chloropropyl group or a 3,3,3-trifluoropropyl group.

The hydrosilylation catalyst (component C) can be any compounds containing Group 8-10 transition metals (e.g., ruthenium, rhodium, platinum, palladium) complexes, but most preferably a platinum complex. Such platinum complexes may include, but are not limited to, fine platinum powder, platinum black, platinum adsorbed on solid supports such as alumina, silica or activated carbon, choroplatinic acid, platinum tetrachloride, platinum compounds complexed with olefins or alkenyl siloxanes such as divinyltetramethyldisiloxanes and tetramethyltetravinylcyclotetrasiloxane. Detailed structures of the catalysts are known to those skilled in the art.

Catalyst inhibitors (component D) can be optionally included to modify the curing profile and achieve the desired shelf life. Suitable inhibitors include, but are not limited to, phosphine or phosphite compounds, sulfur compounds, amine compounds, isocyanurates, alkynyl alcohols, maleate and fumarate esters, mixtures thereof, and any other compounds known to those skilled in the art. Some representative examples of suitable inhibitors include triallylisocyanurate, 2-methyl-3-butyn-2-ol, triphenylphosphine, tris(2,4-di-(tert)-butylphenyl)phosphite, diallyl maleate, diethyl sulfide and mixtures thereof.

Adhesion promoters (component E) which can be employed include alkoxy- or aryloxysilanes such as y-aminopropyltrimethoxysilane, 3-glycidoxypropyltrimethoxysilane and bis(trimethoxysilylpropyl)fumarate, or alkoxy- or aryloxysiloxanes such as tetracyclosiloxanes modified with acryloxytrimethoxysilyl or methacryloxypropyltrimethoxysilyl functional groups. They may also include, but are not limited to, silanols, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group, titanates, trialkoxy aluminum, tetraalkoxysilanes, isocyanurates, and mixtures thereof. The adhesion promoters are used in an effective amount which is typically in a range between about 0.01% by weight and about 5% by weight of the total final formulation.

In the final formulation, the ratios of different components are adjusted so that the Si-H to alkenyl molar ratio ranges from about 0.5 to about 5.0 and preferably from about 0.8 to about 2.0. Si—H radicals used in determining the molar ratio include those existing in both the polyorganohydrogensiloxane (component B) and any other components of the final formulation, such as adhesion promoters (component E). The alkenyl radicals used in the calculation include those existing in all components of the formulation, which include but are not limited to organopolysiloxanes, the adhesion promoter, the catalyst and catalyst inhibitor.

Reactive organic diluents may also be added to the total curable composition to decrease the viscosity of the composition. Examples of reactive diluents include, but are not limited to, various dienes (e.g., 1,5-hexadiene), alkenes (e.g., n-octene), styrenic compounds, acrylate or methacrylate containing compounds and combinations thereof. An unreactive diluent may also be added to the composition to decrease the viscosity of the formulation. Examples of unreactive diluents include, but are not limited to, low boiling aliphatic hydrocarbons (e.g., octane), toluene, ethylacetate, butyl acetate, 1-methoxy propyl acetate, ethylene glycol, dimethyl ether, polydimethylsiloxane fluids and combinations thereof.

Pigments and/or pigments mixed with a carrier fluid (such as in a pigment masterbatch) may also be added to the formulation.

Flame retardants can be optionally used in the final formulation in a range between about 0.5 weight % and about 20 weight % relative to the amount of the final formulation. Examples of flame retardants include phosphoramides, triphenyl phosphate (TPP), resorcinol diphosphate (RDP), bisphenol-a-diphosphate (BPA-DP), organic phosphine oxides, halogenated epoxy resin (tetrabromobisphenol A), metal oxides, metal hydroxides, and combinations thereof.

Where epoxy resins are utilized, hardeners such as carboxylic acid-anhydride curing agents and an organic compound containing hydroxyl moiety can be added as optional reagents with the curing catalyst. For epoxy resins, exemplary anhydride curing agents typically include methylhexahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, and the like. Combinations comprising at least two anhydride curing agents may also be used. Illustrative examples are described in “Chemistry and Technology of the Epoxy Resins” B. Ellis (Ed.) Chapman Hall, New York, 1993 and in “Epoxy Resins Chemistry and Technology”, edited by C. A. May, Marcel Dekker, New York, 2nd edition, 1988.

Where epoxy resins are used, curing catalysts may be selected from, but are not limited to, amines, alkyl-substituted imidazole, imidazolium salts, phosphines, metal salts, triphenyl phosphine, alkyl-imidazole, and aluminum acetyl acetonate, iodonium compounds and combinations thereof. For epoxy resins, curing agents such as multi-function amines can be optionally incorporated as cross-linking agents. Exemplary amines may include, but are not limited to ethylene diamine, propylene diamine, 1,2-phenylenediamine, 1,3-phenylene diamine, 1,4-phenylene diamine, and any other compounds containing 2 or more amino groups.

Reactive organic diluents may also be added to the total curable composition based on an epoxy resin to decrease the viscosity of the composition. Examples of reactive diluents include, but are not limited to, 3-ethyl-3-hydroxymethyl-oxetane, dodecylglycidyl ether, 4-vinyl-1-cyclohexane diepoxide, di(Beta-(3,4-epoxycyclohexyl)ethyl)-tetramethyldisiloxane, and combinations thereof. An unreactive diluent may also be added to the composition to decrease the viscosity of the formulation. Examples of unreactive diluents include, but are not limited to, low boiling aliphatic hydrocarbons (e.g., octane), toluene, ethylacetate, butyl acetate, 1-methoxy propyl acetate, ethylene glycol, dimethyl ether, and combinations thereof.

The fillers can be micron-sized, sub-micron-sized, nano-sized, or a combination thereof. The fillers are thermally conductive materials, and can be reinforcing or non-reinforcing. Fillers can include, for example, fumed silica, fused silica, finely divided quartz powder, amorphous silicas, carbon black, graphite, diamond, metals (such as silver, gold, aluminum, and copper), silicone carbide, aluminum hydrates, metal nitrides (such as boron nitride, and aluminum nitrides), metal oxides (such as aluminum oxide (alumina), zinc oxide, titanium dioxide or iron oxide) and combinations thereof. In some useful embodiments, a combination of the above materials may be utilized as a filler, e.g., a combination of aluminum with alumina. In other useful embodiments, a metal nitride such as boron nitride may be utilized as a filler.

The diameter of the filler particles is selected to achieve the desired bond line thickness. In a particularly useful embodiment, the average particle diameter of the filler does not exceed 25 microns, and preferably ranges from about 0.01 microns to about 15 microns, with a range of from about 0.1 microns to about 10 microns being more preferred. In some cases a commercially available alumina filler, such as AA04 from Sumitomo, may be used. This filler possesses particles having an average diameter of about 0.4 microns.

The filler is typically present in a range between about 10 weight % and about 95 weight %, based on the weight of the total final composition. More typically, the filler is present in a range between about 20 weight % and about 92 weight %, based on the weight of the total final composition. In one embodiment the filler may be a combination of a metal, such as aluminum, with a metal oxide such as alumina. In such a case, the ratio of metal to metal oxide in the filler can range from about 1:10 by volume to about 10:1 by volume. In a particularly useful embodiment, the ratio of metal to metal oxide in the filler can be about 4:1 by volume.

The selection of the filler size is established in order to achieve a thinner bond line than otherwise possible with standard formulations. The choice is such that the maximum particle size is at least equal to, and preferably less than, the desired bond line thickness. The filler distribution is preferably such that the possibility of agglomeration among larger particles is minimized, so that the maximum size of filler agglomerate is equal to or less than the desired bond line thickness. Preferably, the bond line thickness of thermal interface materials made from the compositions of the present disclosure is from about 0.01 mil to about 5 mil, with a bond line thickness of <3.5 mil, ranging from about 0.02 mil to about 3.2 mil, being particularly useful. In one particularly useful embodiment, the bond line thickness can range from about 0.03 mil to about 3 mil.

The manner in which the filler is combined with the matrix is critical not only to the rheology (e.g., viscosity) of the final formulation but also the formulation's in-situ thermal performance. The fillers may be used as received or may be treated prior to or during mixing. Filler treatments include, but are not limited to, ball-milling, jet-milling, chemical or physical coating or capping via procedures such as treating fillers with chemicals such as silazanes, silanols, silane or siloxane compounds or polymers containing alkoxy, hydroxy or Si—H groups and any other commonly used filler-treatment reagents, and any other procedures commonly adopted by those skilled in the art. The final formulation can be hand-mixed or mixed by standard mixing equipment such as dough mixers, change can mixers, planetary mixers, twin screw extruders, two or three roll mills and the like. The blending of the formulations can be performed in batch, continuous, or semi-continuous mode by any means used by those skilled in the art.

Using fillers in accordance with the present disclosure provides enhanced thermal resistance while maintaining sufficiently low viscosities to allow easy processing and which will flow as necessary for preparation of electronic devices, especially flip/chip devices.

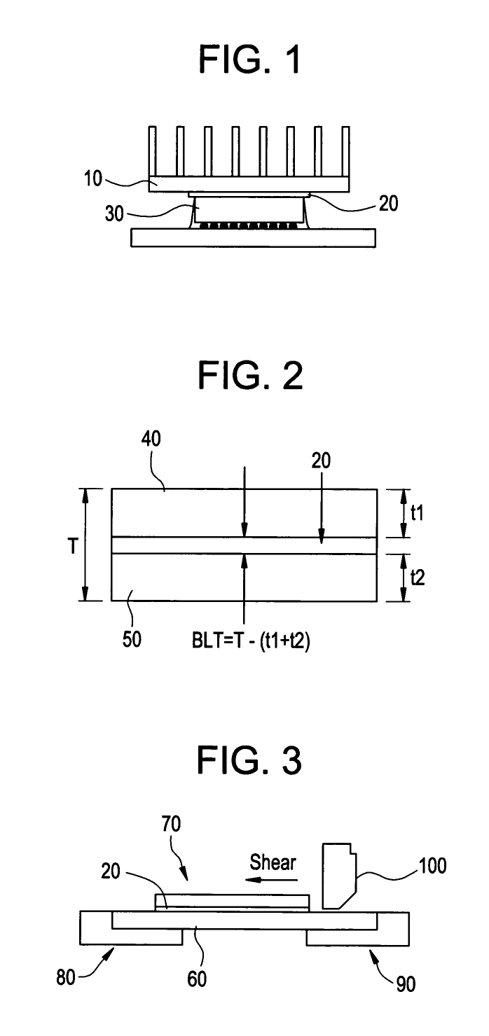

As shown schematically in FIG. 1, a thermal interface composition 20 can be interposed under prescribed pressure between a heat generating component 30 and a heat dissipating unit 10 to fill any air gaps and facilitate heat transfer. Application of the present thermal interface compositions may be achieved by any method known in the art. Conventional methods include screen printing, stencil printing, syringe dispensing, pick-and-place equipment and pre-application to either the heat generating or heat dissipating unit.

The bond line thickness can be further controlled by the viscosity of the thermal interface composition and filler treatments as well as pressure used to interpose the thermal interface material. Viscosity may be modified by both adjusting the composition of the thermal interface composition, as well as the processing conditions. For example, the viscosity of the composition can be adjusted by the amount of filler loading, the ionic contents in the filler, the surface area of the filler, the particle size distribution of the filler, the functional groups on the surface of the filler, the viscosity and purity of the polymer matrix utilized, the amount of adhesion promoters and any other methods known to those skilled in the art. The viscosity may also be modified by adjusting processing conditions such as the mixing speed, mixing time, temperature of mixing, level of vacuum, order of addition, extent of filler treatment and any other processing parameters known to those skilled in the art. The minimum achievable bond line thickness may also be affected by mechanical procedures such as ball-milling of fillers. Suitable viscosities to obtain the bond line thicknesses range from about 5,000 to about 300,000 cps, with a viscosity ranging from about 10,000 to about 200,000 cps being preferred. The viscosity is measured at a shear rate between 1-10/sec.

For example, applying a formulation with a viscosity of 636 Pa-s at 25° C. and a shear rate of 1/sec under 10 psi assembly pressure gives an average bondline thickness of 3 mil (between Al—Al), whereas under the same pressure, the same formulation with a viscosity of 1251 Pa-s at 25° C. and a shear rate of 1/sec has an average bondline thickness of 3.8 mil (between Al—Al). In another example, under the same application pressure, a formulation containing ball-milled fillers have an average bondline thickness of 0.7 mil (between Al—Al) versus 1.0 mil (between Al—Al) for one using as-received fillers. When applied at 10 psi, one formulation had an average bondline of 2.9 mil (between Al—Si) versus 1.4-1.5 mil (between Al—Si) at a pressure of 30 psi and above. Lower viscosity of the thermal interface composition and the smaller particle size of the fillers used in the composition also lower the interfacial or contact resistance between the thermal interface material and the heat generating and/or heat dissipating units, which leads to ultimately reduced in-situ thermal resistance and improved thermal performance.

The interposed formulation can be cured at a temperature in a range between about 20° C. and about 250° C., more typically in a range between about 20° C. and about 150° C. Curing typically occurs at a pressure in a range between about 1 atmosphere (“atm”) and about 5 tons pressure per square inch, more typically in a range between about 1 atmosphere and about 100 pounds per square inch (“psi”). Pressure utilized in forming the TIM of the present disclosure may be applied by any means known to those skilled in the art including a manual force gauge, pick-and-place equipment and a robotic arm. In one embodiment, pressures utilized to obtain the desired bond line thickness range from about 1 psi to about 250 psi, with a range of from about 1 to about 100 psi being preferred.

In order to achieve higher filler loadings and thus higher bulk thermal conductivity while not adversely impacting viscosity and processing characteristics, in one embodiment a bi-modal and multi-modal distribution of fillers are used. For example, one silicone formulation containing 84.6 wt % of Showa Denko's AS40 has a viscosity of 193.7 Pa-s at 25° C. at a shear rate of 1/sec; but the same formulation containing 84.6 wt % of a 4:1 mixture of Denka's AS40 and Sumitomo's AA04 has a viscosity of 84.8 Pa-s at 25° C. at a shear rate of 1/sec. The lower viscosity of the latter composition means that more fillers can be added to it before it reaches the same viscosity of the first composition. Since more fillers typically translate to a higher bulk thermal conductivity, the composite containing mixtures of AS40 and AA04 can achieve higher bulk thermal conductivity than one containing only AS40 at comparable viscosity.

In addition, curing may typically occur over a period of time ranging from about 30 seconds to about 5 hours, and more typically in a range between about 90 seconds and about 2 hours. Optionally, the cured composition can be post-cured at a temperature ranging from about 100° C. to about 200° C. over a period of time ranging from about 1 hour to about 4 hours.

In accordance with the present disclosure, by using fillers having maximum particle diameters below 25 microns, thinner bond lines become achievable in the resulting TIM application. Since thermal resistance decreases with decreasing bond lines provided that the interfacial resistance remains the same, the in-situ thermal resistance can be reduced while the heat conducting ability of the material is increased. Furthermore, by adjusting the processing conditions and therefore the formulations' rheology, interfacial contact resistances may also be minimized to achieve lower thermal resistance and optimal heat transfer rate. Processing conditions which may be adjusted include mixing time, mixing speed, temperature, humidity, vacuum level, order of addition and filler treatment. For example, when one formulation was mixed at a mixing speed of 60 rpm, a hard dough was obtained. When processed at 18 rpm, however, a flowable material was obtainable. The viscosity of this formulation also increased with increasing mixing time. For another formulation, the viscosity decreased upon treating the filler with a mixture of polyorganosiloxane and polyorganohydrogensiloxane for increasing time. Compared to commercially available electrically insulating adhesives, the compositions of the present disclosure provide reduced in-situ thermal resistance. The thermal resistance of the resulting TIM can range from about 0.01 mm²-C/W to about 80 mm²-C/W, preferably from about 0.05 mm²-C/W to about 50 mm²-C/W.

The composition of the present disclosure has reasonable adhesion to metal substrates, and shows no appreciable degradation in thermal or mechanical performance after reliability tests. The present thermal interface compositions can be used in devices in electronics such as computers, semiconductors, or any device where heat transfer between components is needed. Frequently, these components are made of metal, such as aluminum, copper, silicon, etc. While the present disclosure has provided details on how the present compositions may be utilized as thermal interface material in electronic devices, the compositions of the present disclosure may be applied in any situation where heat is generated and needs to be removed. For example, the compositions of the present disclosure may be utilized to remove heat from a motor or engine, to act as underfill material in a flip-chip design, as die attach in an electronic device, and in any other applications where efficient heat-removal is desired.

In another aspect, the present compositions can be pre-formed into sheets or films and cut into any desired shape. In this embodiment, the compositions can advantageously be used to form thermal interface pads or films that are positioned between electronic components. Alternatively, the composition can be pre-applied to either the heat generating or heat dissipating unit of a device. The present compositions may also be applied as grease, gel and phase change material formulations.

In one embodiment, the composition of the present disclosure is a one-part heat cured silicone matrix which contains fine alumina as the filler. Silicone formulations with low modulus and good elongation provide compositions that are able to withstand thermal stress and high humidity-high temperature environments without appreciable material or performance degradation.

In order that those skilled in the art will be better able to practice the present disclosure, the following examples are given by way of illustration and not by way of limitation.

### EXAMPLES

Examples 1-13 pertain to thermally conductive silicone adhesive compositions combined with alumina fillers. Table 1 below provides properties of each of the 4 different alumina fillers used in these example formulations.

TABLE 1
Filler Properties

| | Filler A | Filler B | Filler C | Filler D |
|---|---|---|---|---|
| filler distribution type | multi- | mono- | mono- | Unknown |
| | modal | modal | modal | |
| | above | above 1 | above 1 | |
| | 0.1 | micron | micron | |
| | micron | | | |
| average particle size (μm) | 10-12 | 5 | 5 | 0.3-0.5 |
| Maximum particle size (μm) | 88 | 24 | 24 | <5 |
| ionic impurity (Cl−) (ppm) | 2 | 1.0 | 0.5 | Unknown |
| ionic impurity (Na+) (ppm) | 15 | 180 | 5.0 | <15 |
| ionic impurity (Fe++) (ppm) | unknown | <20 | <20 | <20 |
| electrical conductivity | 28 | 160 | 5.5 | Unknown |
| (μS/cm) | | | | |
| surface area (m²/g) | 1.0 | 0.5 | 0.5 | 3.4-4.4 |

Filler A was Showa Denko's AS40;
Filler B was Denka's DAM05;
Filler C was Denka's DAW05; and
Filler D was Sumitomo's AA04.

### Example 1

Two separate thermally conductive fillers were used in this formulation. The first filler was Filler C and the second filler was Filler D. These two fillers were used in a ratio of 4:1 by weight in this formulation. The thermally conductive fillers (604.29 parts total) were mixed in a lab scale Ross mixer (1 quart capacity) at approximately 18 rpm for 2.5 hours at 140-160° C. at a vacuum pressure of 25-30 inches Hg. The fillers were then cooled to 35-45° C., brought to atmospheric pressure, and 100 parts of vinyl-stopped polydimethylsiloxane fluid (350-450 cSt, approximately 0.48 weight percent vinyl) along with 0.71 parts of a pigment masterbatch (50 weight percent carbon black and 50 weight percent of a 10,000 cSt vinyl-stopped polydimethylsiloxane fluid) and a portion of the hydride fluid was added (0.66 parts of hydride functionalized polyorganosiloxane fluid, approximately 0.82 weight percent hydride). The formulation was mixed at approximately 18 rpm for 6 minutes to incorporate the fluids and pigment. The temperature was then raised to 140-160° C. and the mixture was stirred at approximately 18 rpm for an additional 1.5 hours. The formulation was cooled to approximately 30° C. and the following inputs were added: 0.54 parts triallyl isocyanurate, 0.06 parts 2-methyl-3-butyn-2-ol, and 0.04 parts of a tetramethyltetravinylcyclotetrasiloxane-complexed platinum catalyst (GE Silicones, 88346). The inputs were incorporated by stirring for 8 minutes at approximately 18 rpm. The final inputs were then added to the mixer: 3.14 parts of a first silane adhesion promoter (YC9362 from GE Toshiba), 2.07 parts of a second adhesion promoter (glycidoxypropyltrimethoxysilane), and the remaining amount of the hydride fluid (1.34 parts of hydride functionalized polyorganosiloxane fluid, approximately 0.82 weight percent hydride). The inputs were incorporated by stirring for 5 minutes at approximately 18 rpm. The final formulation was mixed for an additional 3 minutes at approximately 18 rpm and at a vacuum pressure of 25-30 inches Hg. The formulation was removed from the mixer and immediately filtered through a 100 mesh filter screen. The material was then placed under vacuum for 3 minutes at 25-30 inches Hg to remove any residual entrapped air. The material was stored in a refrigerator (−40 to 0° C.) until needed to form a TIM.

Characterization of TIMs. The TIMs were applied between various substrate materials including silicon, aluminum, and copper, and their thermal performance was measured. The laser flash diffusivity method (based on ASTM E-1461) was used to obtain the in-situ or effective thermal resistance and thermal conductivities of the TIMs in a three-layer ‘sandwich’ sample (“Measurements of Adhesive Bondline Effective Thermal Conductivity and Thermal Resistance Using the Laser Flash Method”, Campbell, Robert C, Smith, Stephen E. and Dietz, Raymond L., 15^{th} IEEE Semi-Therm Symposium, 1999, 83-97). In addition to thermal performance, the adhesion of these TIMs to different substrates including silicon, aluminum, and copper was characterized using a die shear test. The reliability of these TIMs was characterized through two accelerated reliability tests: air-to-air thermal shock and temperature/humidity exposure. The change in thermal performance and adhesion strength of the TIMs on reliability cycling was monitored.

Thermal Resistance Measurement Sample Preparation. As depicted in FIG. 2, each TIM 20 was dispensed onto 8 mm×8 mm coupon 40 (silicon, aluminum, or copper) and another coupon 50 (silicon, aluminum, or copper) was placed onto the TIM 20 with a pressure of 10 psi to complete the sandwich. The sandwich was subjected to the TIM curing conditions of two hours at 150° C. to obtain a cured sample. In some examples, no external pressure was exerted during curing; while in the other examples, a 10 psi pressure was applied during curing. The thickness of each coupon 40 and 50 (t1, t2) was measured at five different locations, before sandwich assembly. The thickness of the coupons (t1+t2) was subtracted from the cured sandwich thickness (T) to obtain the Bondline Thickness (BLT) of the TIM 20 (FIG. 2). These sandwiches were then coated with a thin layer of graphite before placing them in a laser flash diffusivity instrument.

Thermal Diffusivity Instrument and Measurement of Thermal Resistance. A laser flash instrument (Netzsch Instruments, Microflash 300) was used for the measurement of in-situ thermal diffusivity and thermal conductivities. A software macro that was provided with the Microflash™ instrument was used to determine the thermal conductivity and thermal resistance of the TIM layer. The thermal resistance of the TIM layer that was determined using this method includes the bulk (intrinsic) thermal resistance of the TIM and the contact resistances at the TIM-substrate interfaces. This thermal resistance value best represents the in-situ performance of the TIMs.

Adhesion Strength Measurement. The adhesive property of the TIMs was characterized using a die shear test, which was performed utilizing a Dage model 22 microtester with a 20 kg load cell. This test is destructive in nature. A schematic representation of the die shear setup is shown in FIG. 3. The TIM 20 was dispensed onto a metallic (aluminum or copper) substrate 60 (50 mm×50 mm) and silicon die 70 (4 mm×4 mm) was then placed onto the TIM deposit 20 with a pressure of 10 psi. Gripping fixtures 80 and 90 held the substrate in place. The samples were cured using the TIM curing conditions of 2 hours at 150° C.

The movement of the shear anvil 100 on the Dage microtester was tightly controlled in the x, y, and z directions. The shear anvil 100 was positioned against the edge of the die 70 with the help of a microscope, and a uniform force was applied until the die either fractured or separated from the substrate/coupon. The type of failure—adhesive or cohesive, was also noted. The load that was required to shear the silicon die off the substrate divided by the shear area yielded the die shear strength.

### Example 2

The formulation and process of this Example followed that of Example 1, with the exception of the filler identity and composition. In this Example, only one filler type was used. Filler A, which had maximal particle sizes exceeding 25 microns, was used exclusively and represented 604.29 total parts of the formulation. The physical properties of this formulation were determined as described above in Example 1.

Formulations with optimal properties were prepared by controlling both the recipe and the mixing parameters. Table 2 below provides a summary of the physical properties for the formulations of Examples 1 and 2. As seen from Table 2, thermal interface materials prepared from Example 1 had a bond line thickness that was approximately 50% lower than those prepared from Example 2. The in-situ thermal resistance of TIM prepared from Example 1 was also about 40% lower than that prepared from Example 2.

TABLE 2
Physical Properties of Examples 1-2

| | | Example | |
|---|---|---|---|
| | | 1 | 2 |
| Physical Properties of | | | |
| Uncured Material | | | |
| Viscosity @ 0.1/sec | Pa-s | — | 963.4 |
| Viscosity @ 1.0/sec | Pa-s | 51.4 | 193.7 |
| Viscosity @ 10.0/sec | Pa-s | 17.7 | 36.6 |
| Physical Properties of | | | |
| Cured Material | | | |
| Lap Shear on Bare Al | Psi | 109 | 129 |
| Tensile Strength | psi | 334 | 333 |
| Elongation | % | 21 | 26 |
| Shore A Hardness | | 83.3 | 81.8 |
| Specific Gravity | | 2.611 | 2.665 |
| Dielectric Strength | V/mil | 434 | 396 |
| Dielectric Constant | @ 1 kHz | 4.2 | 5.8 |
| Dissipation Factor | @ 1 kHz | 0.002 | 0.001 |
| Volume Resistivity | Ohm-cm | 4.60E+15 | 3.00E+14 |
| Volatiles of Cured | ppm | 40 | 720 |
| Sample | | | |
| In-Situ Physical | | | |
| Properties | | | |
| Sandwich Material = | | Al-TIM-Al | Al-TIM-Al |
| Assembly Pressure (no | | 10 psi | 10 psi |
| cure pressure) | | | |
| Bondline Thickness | mil | 2.3 ± 0.3 | 3.9 ± 0.65 |
| | | (1.7-2.8) | (3.0-4.6) |
| In-situ Thermal | mm²-K/W | 44 ± 4 | 71 ± 5 |
| Resistance@ 25° C. | | (35-51) | (63-80) |
| Die Shear Adhesion(Si—Al) | psi | 372 ± 135 | 235 |
| | | (190-575) | |

### Example 3

Two separate thermally conductive fillers were used in this formulation. The first filler was Filler C and the second filler was Filler D. These two fillers were used in a ratio of 4:1 by weight in this formulation. The thermally conductive fillers (1,028.66 parts total) were mixed in a lab scale Ross mixer (1 quart capacity) at approximately 18 rpm for 2.5 hours at 140-160° C. at a vacuum pressure of 25-30 inches Hg. The fillers were then cooled to 35-45° C., brought to atmospheric pressure, and 100 parts of vinyl-stopped polydimethylsiloxane fluid (200-300 cSt, 0.53-0.71 weight percent vinyl) along with 1.16 parts of a pigment masterbatch (50 weight percent carbon black and 50 weight percent of a 10,000 cSt vinyl-stopped polydimethylsiloxane fluid) and a portion of each of the hydride fluids were added: 0.97 parts of hydride functionalized polyorganosiloxane fluid (0.72-1.0 weight percent hydride) and 5.73 parts of hydride stopped polydimethylsiloxane fluid (500-600 ppm hydride).

The formulation was mixed at approximately 18 rpm for 6 minutes to incorporate the fluids and pigment. The temperature was then raised to 140-160° C. and the mixture was stirred at approximately 18 rpm for an additional 1.5 hours. The formulation was cooled to approximately 30° C. and the following inputs were added: 0.66 parts triallyl isocyanurate, 0.07 parts 2-methyl-3-butyn-2-ol, and 0.04 parts a tetramethyltetravinylcyclotetrasiloxane-complexed platinum catalyst (GE Silicones, 88346). The inputs were incorporated by stirring for 8 minutes at approximately 18 rpm. The final inputs were then added to the mixer: 4.24 parts of a first silane adhesion promoter (YC9632 from GE Toshiba), 2.79 parts of a second adhesion promoter (glycidoxypropyltrimethoxysilane), and the remaining amounts of the two hydride fluids: 1.97 parts of hydride functionalized polyorganosiloxane fluid (0.72-1.0 weight percent hydride) and 11.64 parts of hydride-stopped polydimethylsiloxane fluid (500-600 ppm hydride). The inputs were incorporated by stirring for 5 minutes at approximately 18 rpm. Entrapped air was removed from the formulation by mixing an additional 3 minutes at approximately 18 rpm and at a vacuum pressure of 25-30 inches Hg. The formulation was removed from the mixer and immediately filtered through a 100 mesh filter screen. The material was then placed under vacuum for 3 minutes at 25-30 inches Hg to remove any residual entrapped air. The material was stored in a refrigerator (−40 to −0° C.) until needed.

The physical properties of this formulation were determined as described above in Example 1.

### Example 4

The formulation and process of Example 4 followed that of Example 3, with the exception that none of the pigment masterbatch utilized in Example 3 was included in the formulation of Example 4. The physical properties of this formulation were determined as described above in Example 1.

### Example 5

The formulation and process of this example followed that of Example 4, with the exception that the first thermally conductive filler was Filler B and the second filler was Filler D. These two fillers were used in a ratio of 4:1 by weight in this formulation. As in Example 4, the thermally conductive fillers represented 1,028.66 parts of the total formulation. The process of Example 4 was followed for this formulation, up to the point where the adhesion promoters and the final addition of the hydride fluids is typically done. At that point, the formulation was no longer flowable and could not be mixed any further. A repeat of Example 5 was attempted to check this result. The repeat formulation showed the same behavior as Example 5. These samples were discarded. As seen from this example, the ionic contents of the filler may have an impact on the final rheology of the formulation.

### Example 6

The formulation and process of Example 6 followed that of Example 4, with the exception of the vinyl fluid input. In Example 6, the vinyl fluid used (100.00 parts) was vinyl-stopped and had 0.4-0.6 weight percent vinyl and a viscosity of approximately 200 cSt from Gelest. The physical properties of this formulation were determined as described above in Example 1.

### Example 7

The formulation and process of Example 7 followed that of Example 6, with the exception that the first thermally conductive filler was Filler B and the second thermally conductive filler was Filler D. These two fillers were used in a ratio of 4:1 by weight and represented 1,028.66 parts of the total formulation. The physical properties of this formulation were determined as described above in Example 1.

### Example 8

The formulation and process of Example 8 followed that of Example 7, with the exception of the filler used. As in Example 7, 1028.66 parts total of the two thermally conductive fillers were added in a ratio of 4:1 by weight. However, in Example 8, these fillers (Filler B and Filler D) were pre-mixed at the desired ratio and were ball-milled for approximately 72 hours prior to their incorporation in the formulation at the first processing step. The physical properties of this formulation were determined as described above in Example 1.

Table 3 below provides a physical property summary for the formulations of Examples 3-4 and 6-8. As seen from Table 3, the formulation containing ball-milled fillers (Example 8) had a lower bond-line thickness than comparable formulations using as received-fillers, and showed lower in-situ thermal resistance and better heat transfer capabilities.

TABLE 3
Physical Properties of Examples 3-4 and 6-8

| | | Example | | | | |
|---|---|---|---|---|---|---|
| | | 3 | 4 | 6 | 7 | 8 |
| Physical Properties | | | | | | |
| of Uncured Material | | | | | | |
| Viscosity @ 0.1/sec | Pa-s | 3020.0 | 2348 | 2251 | 2566 | 2861 |
| Viscosity @ 1.0/sec | Pa-s | 635.9 | 497.1 | 445.5 | 719.5 | 764.5 |
| Viscosity @ 10.0/sec | Pa-s | 126.5 | 80.54 | 96.52 | 169 | 157.2 |
| Physical Properties | | | | | | |
| of Cured Material | | | | | | |
| Lap Shear on Bare | psi | 155 | 158 | 114 | 187 | 117 |
| Al | | | | | | |
| Tensile Strength | psi | 482 | 546 | 511 | 342 | 379 |
| Elongation | % | 19 | 27 | 17 | 10 | 14 |
| Shore A Hardness | | 96.8 | 97.0 | 97.7 | 94.5 | 95.9 |
| Specific Gravity | | 2.806 | 2.848 | 2.861 | 2.858 | 2.862 |
| Dielectric Strength | V/mil | 378 | 444 | 438 | 412 | 404 |
| Dielectric Constant | @ 1 kHz | 4.6 | 6.1 | 6.1 | 6.1 | 6.1 |
| Dissipation Factor | @ 1 kHz | 0.0016 | 0.002 | 0.002 | 0.001 | 0.003 |
| Volume Resistivity | Ohm- | 2.04E+15 | 1.70E+15 | 1.70sE+15 | 1.10E+14 | 1.40E+14 |
| | cm | | | | | |
| Volatiles of Cured | ppm | 720 | 570 | 320 | 420 | 550 |
| Sample | | | | | | |
| In-Situ Physical | | | | | | |
| Properties | | | | | | |
| Sandwich Material = | | Al-TIM- | Al-TIM- | Al-TIM- | Al-TIM- | Al-TIM- |
| | | Al | Al | Al | Al | Al |
| Assembly Pressure | psi | Manual* | Manual* | Manual* | Manual* | Manual* |
| (no cure pressure) | | | | | | |
| Bondline Thickness | mil | 1.3 ± 0.1 | 1.1 ± 0.2 | 1.2 ± 0.3 | 1.0 ± 0.2 | 0.7 ± 0.2 |
| (range) | | (1.2-1.5) | (0.8-1.3) | (1.1-1.8) | (0.75-1.3) | (0.5-0.9) |
| In-situ Thermal | mm²- | 24 ± 3.5 | 24 ± 3 | 25 ± 3 | 20 ± 2 | 17 ± 2 |
| Resistivity @ 25° C. | K/W | (22-30) | (21-29) | (20-31) | (17-22) | (16-21) |
| In-Situ Thermal | W/m-K | 1.4 ± 0.24 | 1.2 ± 0.3 | 1.2 ± 0.2 | 1.3 ± 0.2 | 1.1 ± 0.2 |
| Conductivity @ | | (1.1-1.7) | (0.83-1.4 ) | (1.0-1.5) | (0.95-1.5) | (0.7-1.3) |
| 25° C. | | | | | | |
| Die Shear Adhesion | psi | 224 | 253 ± 25 | 359 ± 153 | 178 ± 16 | 231 ± 37 |
| (Al—Si) | | | (225-300) | (225-675) | (150-200) | (175-275) |

*Used a spatula to bottom out the formulation; average of 8 samples.

### Example 9

the formulation and process of Example 9 followed that of Example 3, with the exception of the processing times for two of the steps of the process. In Example 3, the thermally conductive fillers (1,028.66 parts total) were mixed in a lab scale Ross mixer (1 quart capacity) at approximately 18 rpm for 2.5 hours at 140-160° C. at a vacuum pressure of 25-30 inches Hg. For the formulation of Example 9, the filler mixture was mixed at approximately 18 rpm at room temperature for 1 hour at a vacuum pressure of 25-30 inches Hg and then was mixed at approximately 18 rpm for 2.5 hours at 140-160° C. at a vacuum pressure of 25-30 inches Hg. In Example 3, after adding the vinyl fluid and portions of the two hydride fluid inputs, the formulation was mixed at approximately 18 rpm for 6 minutes to incorporate the fluids and pigment. The temperature was then raised to 140-160° C. and the mixture was stirred at approximately 18 rpm for an additional 1.5 hours. For the formulation of Example 9, the formulation was mixed at approximately 18 rpm for 36 minutes after the addition of the fluids was made, prior to raising the temperature to 140-160° C. and stirring at approximately 18 rpm for an additional 1.5 hours. The physical properties of this formulation were determined as described above in Example 1.

Table 4 below provides a comparison of the physical properties for the formulations of Examples 3 and 9. As seen in Table 4, change in mixing time resulted in formulations of different viscosities. The lower viscosity formulation (Example 3) showed both thinner bond lines and lower thermal resistance than the higher viscosity formulation (Example 9).

TABLE 4
Physical Properties of Examples 3 & 9

| | | Example | |
|---|---|---|---|
| | | 3 | 9 |
| Physical Properties of | | | |
| Uncured Material | | | |
| Viscosity @ 0.1/sec | Pa-s | 3020.0 | 5180 |
| Viscosity @ 1.0/sec | Pa-s | 635.9 | 1251 |
| Viscosity @ 10.0/sec | Pa-s | 126.5 | 220.3 |
| Physical Properties of Cured | | | |
| Material | | | |
| Lap Shear on Bare Al | Psi | 155 | 153 |
| Tensile Strength | Psi | 482 | 483 |
| Elongation | % | 19 | 20 |
| Shore A Hardness | | 96.8 | 97.2 |
| Specific Gravity | | 2.806 | 2.844 |
| Dielectric Strength | V/mil | 378 | 399 |
| Dielectric Constant | @ 1 kHz | 4.6 | 4.6 |
| Dissipation Factor | @ 1 kHz | 0.0016 | 0.0016 |
| Volume Resistivity | Ohm-cm | 2.04E+15 | 2.34E+15 |
| Volatiles of Cured Sample | ppm | 720 | 590 |
| In-Situ Physical Properties | | | |
| Sandwich Material = | | Al-TIM-Al | Al-TIM-Al |
| Assembly Pressure (no cure | psi | 10 psi | 10 psi |
| pressure) | | | |
| Bondline Thickness (range) | mil | 3.0 ± 0.5 | 3.8 ± 0.7 |
| | | (2.2-4.0) | (2.8-5.2) |
| In-situ Thermal Resistivity | mm²-K/W | 46 ± 8 | 59 ± 9 |
| @25° C. (range) | | (31-62) | (45-68) |
| In-situ Thermal Conductivity | W/m-K | 1.7 ± 0.4 | 1.7 ± 0.3 |
| @25° C. (range) | | (1.1-2.5) | (1.2-2.0) |
| Die Shear Adhesion (Al—Si) | psi | 215 ± 95 | 225 ± 69 |
| | | (175-450) | (175-375) |
| Die Shear Adhesion (Cu—Si) | psi | 337 | |

* Used a spatula to bottom out the formulation; average of 8 samples.

### Example 10

Alumina fillers B and D were mixed in 4:1 ratio. The mixture was ball-milled with alumina grinding balls for 77.5 hours, and was then stored in a 130° C. oven.

100 parts of a 200 cps heat-treated vinyl-terminated polydimethylsiloxane fluid (DMSV22, Gelest) was blended with 1056 parts of the above alumina mixture, first by hand, then in a Waring pulverizer mounted on a Waring 2-speed blender base. The speed of the pulverizer was controlled by both the HI/LO selection button on the blender base and the setting of the variac, to which the blender base was connected. The pulverizer was wrapped in a heating tape, which was connected to a second variac. The pulverizer was heated to 110° C., and the speed of mixing was set to LO, 40. The blender was periodically stopped, the sides and the bottom were scraped, and the blender was then re-started. This process was repeated over a period of 1 hr and 15 minutes. During this period, the mixing speed was briefly increased 3-4 times to HI, 70 for 30-60 seconds each time. To this mixture, 5.0-5.8 parts of a silicon-hydride fluid mixture was added. The silicon-hydride fluid mixture consisted of, in 5.92:1.00 weight ratio, a 45-55 cps silicone-hydride terminated polydimethylsiloxane (GE Silicones, 89006, cyclics removed) and a 30-75 cps polydimethyl-co-methylhydrogen-siloxane containing 0.72-1.0 weight percent hydride (88466 from GE Silicones). The combined mixture was blended in the pulverizer at LO, 25 for 25 minutes, after which time, the heat was turned off while the mixing continued for another 25 minutes.

Approximately 97.4% of the above mixture was then transferred to a jar, and left in a 75° C. vacuum oven for 20.5 hours. The temperature of the oven was then turned down to 40° C., and kept there for another 48 hours. The vacuum gauge read between 25-27 inHg.

To this mixture was added 1.8-2.3 part of the above silicon-hydride mixture, 0.73 parts of a platinum catalyst inhibitor package (mixture of 75:8 by weight triallylisocyanurate (TAIC):2-methyl-3-butyn-2-ol (surfinol)), and 2.4 parts of a stock solution of a tetramethyltetravinylcyclotetrasiloxane-complexed platinum catalyst (GE Silicones, 88346) in vinyl-terminated polydimethylsilxoane ([Pt]=255ppm). The resulting mixture briefly mixed by hand, and then thoroughly mixed on Speedmixer (FlackTek Inc., Model # DAC400FV) for 5 seconds at 900 rpm, and then another 5 seconds at 2000 rpm. This yielded a non-flowable thick paste. To this thick paste was added 12.3-13.8 parts of the above silicon-hydride mixture and 7.0 parts of mixtures of adhesion promoters (44:29 by weight YC9362 (a silane adhesion promoter from GE Toshiba) and glycidoxypropyltrimethoxysilane (GLYMO)). The mixture was first briefly mixed by hand, then thoroughly mixed by Speedmixer for 5 seconds at 900 rpm to yield a thick paste. The final formulation contained: 102.4 parts vinyl-terminated polydimethylsiloxanes, 20.8 parts of the above silicon-hydride mixture, 0.73-0.75 parts of the platinum catalyst inhibitors package (TAIC and surfinol, as defined above), 5 ppm platinum catalyst, 7.2 parts adhesion promoters (YC9632 and GLYMO) and 1050-1060 parts alumina particles.

The physical properties of this formulation were determined as described above in Example 1.

### Example 11

A formulation was prepared in a similar fashion to that outlined in Example 10, except that: 1) during the first stage of mixing, the pulverizer was set to LO, 20, and after addition of the first portion of silicon-hydride mixture, the mixing time was 1.5 hours rather than 50 minutes (this yielded a mixture that appeared much more viscous than that in Example 10 at the similar formulation stage); 2) after addition of the second portion of silicon-hydride mixture, catalyst and inhibitors, the mixture was only hand mixed; and 3) after addition of the remaining components of the formulation, the mixture was hand-mixed, and then mixed on Speedmixer for 5 seconds at 900 rpm to yield a semi-flowable paste. The physical properties of this formulation were determined as described above in Example 1.

### Example 12

A formulation was prepared similarly to Example 11, except that a 4:1 mixture of Filler A (which has a maximum particle size exceeding 25 microns) and Filler D was used instead of the 4:1 mixture of Filler B and Filler D. The physical properties of this formulation were determined as described above in Example 1.

Table 5 below shows viscosity of the formulations measured in between two metal coupons for Examples 10 and 11, as well as adhesion strength, bond line thickness and thermal resistance of the formulations measured in between two metal coupons for Examples 10, 11 and 12. As seen in Table 5, different processing speeds produced formulations of different viscosities (Examples 10 and 11). The lower viscosity formulation (Example 10) showed lower in-situ thermal resistance at a bond-line comparable to that of Example 11. Example 12, which contained filler with larger maximum particle size than that of Example 11, had thicker bond-lines and higher thermal resistance than Example 11.

TABLE 5

| | | Example | | |
|---|---|---|---|---|
| | | 10 | 11 | 12 |
| Physical Properties of | | | | |
| Uncured Material | | | | |
| Viscosity @ 0.1/sec | Pa-s | 3122 | 576.7 | — |
| Viscosity @ 1.0/sec | Pa-s | 884.5 | 89.26 | — |
| Viscosity @ 10.0/sec | Pa-s | 149.3 | 47.18 | — |
| In-Situ Physical | | | | |
| Properties | | | | |
| Sandwich Material = | | Al-TIM-Al | Al-TIM-Al | Al-TIM-Al |
| Assembly Pressure (no | psi | 10 | 10 | 10 |
| cure pressure) | | | | |
| Bondline Thickness | mil | 2.92 ± 0.46 | 2.50 ± 0.34 | N/A |
| (range) | | (2.1-3.6)¹ | (2.1-3.3)¹ | |
| Sandwich Material = | | Al-TIM-Al | Al-TIM-Al | Al-TIM-Al |
| Assembly Pressure | psi | Manual² | Manual² | Manual² |
| Bondline Thickness | mil | 0.80 ± 0.16 | 0.86 ± 0.14 | 2.35 ± 0.5 |
| (range) | | (0.57-0.98)³ | (0.72-1.09)³ | (1.7-3.0)⁴ |
| In-situ Thermal | mm²-K/W | 30 ± 6 | 23 ± 5 | 30 ± 2 |
| Resistivity @25° C. | | (21-39)³ | (19-34)³ | (27-32)⁴ |
| (range) | | | | |
| In-situ Thermal | W/m-K | 0.69 ± 0.09 | 0.97 ± 0.20 | 2.00 ± 0.4 |
| Conductivity @25° C. | | (0.56-0.85)³ | (0.68-1.27)³ | (1.6-2.42)⁴ |
| (range) | | | | |
| Die Shear Adhesion (Al—Si) | psi | 366 ± 158 | 394 ± 112 | 444 ± 203 |
| | | (200-625)³ | (275-550)³ | (225-650)³ |
| Die Shear Adhesion (Cu—Si) | psi | 337 | | |

¹average of 10 samples;
²Used a spatula to bottom out the adhesive layer;
³average of 8 samples;
⁴average of 5 samples.

### Example 13

Reliability Testing. In addition to “as assembled” thermal resistance and adhesion strength measurements, the compositions of Examples 1 and 3 were used to make TIMs which were subjected to accelerated reliability testing to determine their ability to survive high stress environments. The two reliability testing methods were Air-to-Air Thermal Shock and Temperature/Humidity Exposure.

For Air-to-Air Thermal Shock, aluminum-TIM-silicon sandwich samples were assembled for thermal and adhesion measurements, as described above. The samples for thermal measurement were coated with graphite, and their thermal resistance was measured at room temperature (25° C.) and at 125° C. These samples were then subjected to air-to-air thermal shock between temperatures of −55° C. and 125° C., with 10 minute dwells at each temperature extreme. After 500 such cycles, the thermal resistance of the TIMs was measured at 25° C. and 125° C. and the change in thermal resistance on thermal cycling was determined.

Similarly, silicon die on aluminum substrates were sheared off to obtain the die shear strength of the TIMs. Similar samples were subjected to 500 air-to-air thermal shocks and the change in adhesion strength as a function of thermal shock was determined.

For the Temperature/Humidity Exposure, the aluminum-TIM-silicon sandwich samples were assembled for thermal and adhesion measurements, as described above. The samples for thermal measurement were coated with graphite, and their thermal resistance was measured at room temperature (25° C.) and at 85° C. These samples were then subjected to 85° C. and 85% relative humidity for 250 hours. The thermal resistance of the TIMs after 250 hours of temperature/humidity exposure was measured at 25° C. and 85° C. and the change in thermal resistance was determined.

Table 6 below provides a summary of the conditions of the two reliability tests that the TIM sandwiches were subjected to. The thermal performance and adhesion strength of the TIMs were measured before and after reliability testing and the results of those tests are set forth below in Table 7. As seen from Table 7, adhesion increased after reliability testing, and thermal performance either improved slightly (Example 3) or showed no appreciable degradation (Example 1).

TABLE 6
Reliability Tests

| Reliability Test | Test Conditions | Duration of Test |
|---|---|---|
| Air to Air Thermal | −55° C. to +125° C., dwell time | 500 Cycles |
| Shock | of 10 minutes at each extreme | |
| Temperature/ | 85° C./85% RH | 250 Hours |
| Humidity | | |

TABLE 7
AATS Reliability Data for Example 1 & 3

| In-Situ | | | | | |
|---|---|---|---|---|---|
| Physical | | | | | |
| Properties | | 3 | | 1 | |
| Sandwich | | Al-TIM-Si | | Al-TIM-Si | |
| Material = | | | | | |
| Assembly | psi | 10 | | 10 | |
| Pressure | | | | | |
| Cycles | | 0 | 500 | 0 | 500 |
| Bondline | mil | 3.19 ± 0.34 | | 2.29 ± 0.32 | |
| Thickness | | (2.7-4.1) | | (1.7-2.9) | |
| (range)¹ | | | | | |
| In-situ | mm²- | 49 ± 4 | 44 ± 3 | 45 ± 4 | 49 ± 4 |
| Thermal | K/W | (43-55) | (39-49) | (38-51) | (41-55) |
| Resistance @ | | | | | |
| 25° C. (range)¹ | | | | | |
| In-situ Thermal | mm²- | 63 ± 6 | 57 ± 3 | 60 ± 5 | 63 ± 5 |
| Resistance @ | K/W | (55-72) | (51-64) | (52-67) | (55-75) |
| 125° C. | | | | | |
| (range)¹ | | | | | |
| Die Shear | psi | 224 ± 81 | 428 ± 98 | 372 ± 135 | 549 ± 72 |
| Adhesion | | (130-370) | (300-560) | (190-500) | (470-660) |
| (Al—Si)¹ | | | | | |
| Die Shear | psi | 337 ± 154 | 360 ± 85 | 292 ± 112 | 364 ± 72 |
| Adhesion | | (280-460) | (260-480) | (180-480) | (280-600) |
| (Cu—Si)¹ | | | | | |

¹average of 12 samples

### Example 14

14.1 grams of a 400 cps vinyl-terminated polydimethylsiloxane fluid (SL6000, GE Silicones) was blended with 61.9 grams of an aluminum powder (Al100, 1-5 microns, Atlantic Equipment Engineers), first by hand, then in a Waring pulverizer mounted on a Waring 2-speed blender base. The speed of the pulverizer was controlled by both the HI/LO selection button on the blender base and the setting of the variac, to which the blender base was connected. The pulverizer was wrapped in a heating tape, which was connected to a second variac. The pulverizer was heated to 80-100° C., and the speed of mixing was set to LO, 15-20. The blender was periodically stopped, the sides and the bottom were scraped, and the blender was then re-started. This process was repeated over a period of 2 hrs. 0.10 grams of a silicon hydride fluid (88466, GE Silicones) was then added, and the mixture was stirred for an additional 15-30 minutes. Afterwards, 72.61 grams of the mixture was transferred to a plastic container, and was left in a vacuum oven at 75° C. over night (˜12 hours). The vacuum gauge read between 25-27 inches Hg.

The mixture was allowed to cool to room temperature, and to it was added 0.0792 grams of a platinum catalyst inhibitor package (mixture of 75:8 by weight triallylisocyanurate (TAIC) to 2-methyl-3-butyn-2-ol (surfinol)), and 0.1336 grams a stock solution of a tetramethyltetravinylcyclotetrasiloxane-complexed platinum catalyst (GE Silicones, 88346) in vinyl-terminated polydimethylsilxoane SL6000 ([Pt]=570 ppm). The resulting mixture was briefly mixed by hand, and then to it was added 0.1746 grams of the silicon hydride fluid (88466, GE Silicones) and 0.6965 grams of a mixture of adhesion promoters (44:29 by weight mixture of YC9632 (a silane adhesion promoter from GE Toshiba) to glycidoxypropyltrimethoxysilane (GLYMO)). The mixture was then mixed briefly by hand, and then thoroughly mixed with a speedmixer (FlackTek Inc., Model # DAC400FV) at 1200 rpm for 5 seconds. The mixture was then degassed at room temperature for 15-24 hours (vacuum gauge<1 mmHg). The final mixture contained 100 parts by weight vinyl-terminated polydimethylsiloxanes (SL6000), 1.978 parts by weight of the above silicon-hydride mixture, 0.588 parts by weight of the platinum catalyst inhibitor package (TAIC and surfinol, as described above), 5 ppm platinum catalyst, 5.14 parts by weight of the adhesion promoters (YC9632 and GLYMO) and 435 parts by weight of the filler particles.

The mixture was then interposed between AlCr and Si coupons and cured under 10 psi pressure. The diffusivity of the resulting sandwiched structure was then determined by laser flash as described above in Example 1 (Netzsch Instrument, Microflash™ 300), and the in-situ thermal resistivity determined by a software macro provided with the Microflash™ instrument. 5 samples were prepared utilizing the formulation between the AlCr and Si coupons.

### Comparative Example 1

A formulation was prepared as described above in Example 14, except that an aluminum powder with a maximum size of 325 mesh (44 microns) (Al101, 325 mesh, Atlantic Equipment Engineers) was used. The in-situ thermal performance of the formulation was determined as outlined in Example 14.

Table 8 below shows the average in-situ thermal resistivities and bond line thicknesses for Example 14 and Comparative Example 1. It is evident from the table that formulations containing larger particles led to thicker bond lines and higher thermal resistivities (poorer thermal performance).

TABLE 8

| | | Example | |
|---|---|---|---|
| | | 14 | Comparative 1 |
| Sandwich Material = | | AlCr-TIM-Si | Al-TIM-Si |
| Assembly and Cure Pressure | psi | 10 psi | 10 psi |
| Bondline Thickness (range)* | mil | 1.1 ± 0.2 | 4.5 ± 0.7 |
| | | (0.9-1.3) | (3.3-5.5) |
| In-situ Thermal Resistivity | mm2-K/W | 26 ± 3 | 60 ± 12 |
| @25° C. (range)* | | (23-30) | (39-71) |
| In-situ Thermal Conductivity | W/m-K | 1.1 ± 0.2 | 2.0 ± 0.6 |
| @25° C. (range)* | | (0.9-1.4) | (1.3-3.0) |

*average of 5 samples.

### Example 15

A formulation was prepared as described above in Example 14, except that a mixture of aluminum powder (4:1 volume of Al100:Al104 (Al100 has a size of 1-5 microns, Al104 has a size of 1-3 microns spherical), both available from Atlantic Equipment Engineers) was used. The in-situ thermal performance of the formulation was determined as set forth above in Example 14.

### Comparative Example 2

A formulation was prepared as described above in Example 14, except that a mixture of aluminum powder (4:1 volume Al101:Al104 (Al101 has a size of 325 mesh or 44 microns, Al104 has a size of 1-3 microns spherical), both available from Atlantic Equipment Engineers) was used. The in-situ thermal performance of the formulation was determined as outlined in Example 14.

Table 9 shows the average in-situ thermal resistivities and bond line thicknesses for Example 15 and Comparative Example 2. It is evident from the table that formulations containing larger particles led to thicker bond lines and higher thermal resistivities (poorer thermal performance).

TABLE 9

| | | Example | |
|---|---|---|---|
| | | 15 | Comparative 2 |
| Sandwich Material = | | AlCr-TIM-Si | Al-TIM-Si |
| Assembly and Cure | psi | 10 psi | 10 psi |
| Pressure | | | |
| Bondline Thickness | Mil | 0.9 ± 0.5 | 2.9 ± 0.2 |
| (range)* | | (0.6-1.7**) | (2.5-3.1) |
| In-situ Thermal Resistivity | mm2-K/W | 22 ± 5 | 47 ± 3 |
| @25° C. (range)* | | (19-31**) | (44-52) |
| In-situ Thermal | W/m-K | 1.1 ± 0.3 | 1.6 ± 0.1 |
| Conductivity | | | |
| @25° C. (range)* | | (0.7-1.5) | (1.5-1.8) |

*Average of 5 samples.
**The bond lines were: 1.74 mils, 0.80 mil, 0.80 mil, 0.57 mil and 0.79 mil, and the corresponding thermal resistivities were: 31, 19, 19, 20 and 20 mm2-K/W.

### Example 16

A formulation was prepared as described above in Example 14, except that the aluminum powder was replaced by the same volume of fillers consisting of a mixture of aluminum and alumina powder (4:1 volume Al100:AA04 (Al100 has a size of 1-5 microns and is available from Atlantic Equipment Engineers; AA04 is Filler D described in Example 1 above, average particle size 0.4 micron, maximum size <5 microns, and is available from Sumitomo)). The in-situ thermal performance of the formulation was determined as outlined in Example 14. The dielectric constants and dissipation factors were measured according to ASTM D150 (using an Agilent 16451 B dielectric test fixture with guarded rings).

### Example 17

A formulation was prepared as described above in Example 14, except that the aluminum powder was replaced by the same volume of fillers consisting of a mixture of aluminum and alumina powder (4:1 volume Al104:AA04 (Al104 has a size of 1-3 microns, spherical, and is available from Atlantic Equipment Engineers; AA04 is Filler D, average particle size 0.4 micron, maximum <5 microns, and is available from Sumitomo)). The in-situ thermal performance of the formulation was determined as outlined in Example 14.

### Comparative Example 3

A formulation was prepared as described above in Example 14, except that the aluminum powder was replaced by the same volume of fillers consisting of a mixture of aluminum and alumina powder (4:1 volume Al101:AA04). Al101 is 325 mesh aluminum from Atlantic Equipment Engineers; AA04 is Filler D, alumina powder having average particle size of 0.4 microns, maximum <5 microns, and is available from Sumitomo. The in-situ thermal performance of the formulation was determined as outlined in Example 14.

Table 10 shows the average in-situ thermal resistivities and bond line thicknesses for Examples 16, 17 and Comparative Example 3. It is evident from the table that formulations containing larger particles led to thicker bond lines and higher thermal resistivities (poorer thermal performance).

TABLE 10

| | | Example | | |
|---|---|---|---|---|
| | | 16 | 17 | Comparative 3 |
| Sandwich Material = | | AlCr-TIM-Si | AlCr-TIM-Si | AlCr-TIM-Si |
| Assembly and Cure Pressure | psi | 10 | 10 | 10 |
| Bondline Thickness | mil | 0.74 ± 0.21 | 0.30 ± 0.16 | 4.2 ± 0.7 |
| (range) | | (0.43-1.06)¹ | (0.13-0.64)² | (3.7-5.5)³ |
| In-situ Thermal | mm2- | 16 ± 3 | 11 ± 2 | 50 ± 3 |
| Resistivity @25° C. | K/W | (11-23)¹ | (9-15)² | (47-56)³ |
| (range) | | | | |
| In-situ Thermal | W/m-K | 1.17 ± 0.37 | 0.65 ± 0.24 | 2.14 + 0.22 |
| Conductivity | | (0.68-1.81)¹ | (0.35-1.11)² | (2.0-2.5)³ |
| @25° C. (range) | | | | |

Physical Properties of Cured Formulation

| | | | |
|---|---|---|---|
| Dielectric Constant | 13.2/0.0014 | 9.51/0.002 | — |
| Dissipation Factor (60 Hz) | | | |
| Dielectric Constant | 13.24/0.003 | 9.34/0.004 | — |
| Dissipation Factor (5 MHz) | | | |

¹Average of 8 samples.
²Average of 6 samples.
³Average of 5 samples.

The dielectric constants and dissipation factors were measured according to ASTM D150 (using an Agilent 16451B dielectric test fixture with guarded rings).

### Example 18

A thermally conductive boron nitride single crystal flake-type filler (63.48 parts) (PT120S, having an average particle size of 13 microns in the longest dimension and 1-2 microns in thickness, from GE Advanced Ceramics) was mixed in a lab scale Ross mixer (1 quart capacity) at approximately 60 rpm with 100 parts of vinyl-stopped polydimethylsiloxane fluid (350-450 cSt, approximately 0.48 weight percent vinyl) at 25-35° C., and atmospheric pressure until a smooth consistency was obtained.

To this mixture was added 0.17 parts of a pigment masterbatch (50 weight percent carbon black and 50 weight percent of a 10,000 cSt vinyl-stopped polydimethylsiloxane fluid) and a portion of the hydride fluid was added (0.66 parts of hydride functionalized polyorganosiloxane fluid, approximately 0.82 weight percent hydride.) The formulation was mixed at approximately 60 rpm for 6 minutes to incorporate the fluids and pigment. The temperature was then raised to 140-160° C. and the mixture was stirred at approximately 60 rpm for an additional 1.5 hours. The formulation was cooled to approximately 30° C. and the following materials were added: 0.13 parts triallyl isocyanurate, 0.01 parts 2-methyl-3-butyn-2-ol, and 0.03 parts of a tetramethyltetravinylcyclotetrasiloxane-complexed platinum catalyst (88346 from GE Silicones). The materials were incorporated by stirring for 8 minutes at approximately 60 rpm.

Additional materials were then added to the mixer: 0.74 parts of a first silane adhesion promoter (YC9632 from GE Toshiba), 0.49 parts of a second adhesion promoter (glycidoxypropyltrimethoxysilane), and the second portion of the hydride fluid was added (1.34 parts of hydride functionalized polyorganosiloxane fluid, approximately 0.82 weight percent hydride.) The additional materials were incorporated by stirring for 5 minutes at approximately 60 rpm. The final formulation was mixed for an additional 3 minutes at approximately 60 rpm and at a vacuum pressure of 25-30 inches Hg. The formulation was removed from the mixer and stored in a refrigerator (−40 to 0° C.) until needed to form a TIM. Prior to dispensing the material from a syringe to TIM, the material was filtered through a 100 mesh filter screen to remove any foreign contaminants and then placed under vacuum for 3 minutes at 25-30 inches Hg to remove any residual entrapped air.

To form a TIM, the mixture was interposed between AlCr and Si coupons and cured under 10 psi pressure. The diffusivity and in-situ thermal conductivity of the resulting sandwiched structure was then determined by laser flash (Netzsch Instrument, Nanoflash LFA447.) The in-situ thermal resistance was determined by dividing the TIM bondline thickness by the TIM in-situ thermal conductivity. A total of 6 samples were prepared utilizing the formulation between the AlCr and Si coupons.

### Example 19

A formulation was prepared as described above in Example 18, except that a boron nitride powder (single crystal, flake-type) with an average particle size of 7.5 microns in the longest dimension and 1-2 microns in thickness (CC6004, from GE Advanced Ceramics) was used. The in-situ thermal performance of the formulation was determined as outlined in Example 18. A total of 5 samples were prepared utilizing the formulation between the AlCr and Si coupons.

### Comparative Example 4

A formulation was prepared as described above in Example 18, except that a boron nitride powder (single crystal, flake-type) with an average particle size of 44 microns in the longest dimension and 1-2 microns in thickness (PT110, from GE Advanced Ceramics) was used. The in-situ thermal performance of the formulation was determined as outlined in Example 18. A total of 7 samples were prepared utilizing the formulation between the AlCr and Si coupons.

Table 11 shows the average in-situ thermal resistances and bond line thicknesses for Examples 18, 19 and 20. It is evident from the table that formulations containing larger particles led to thicker bond lines and higher thermal resistances (poorer thermal performance).

TABLE 11

| | | Example | | |
|---|---|---|---|---|
| | | | | Comparative |
| | | 18^{a} | 19^{b} | 4^{c} |
| Sandwich | | AlCr-TIM-Si | AlCr-TIM-Si | AlCr-TIM-Si |
| Material = | | | | |
| Assembly Pressure | psi | 20 psi | 20 psi | 20 psi |
| Cure Pressure | psi | 10 psi | 10 psi | 10 psi |
| Bondline Thickness | mil | 0.53 ± 0.13 | 0.14 ± 0.09 | 0.89 ± 0.42 |
| (range) | | (0.35-0.75) | (0.05-0.26) | (0.50-1.47) |
| In-situ Thermal | mm²- | 31 ± 6 | 26 ± 5 | 65 ± 7 |
| Resistivity @25° C. | K/W | (24-41) | (22-35) | (57-73) |
| (range) | | | | |
| In-situ Thermal | W/m-K | 0.43 ± 0.04 | 0.15 ± 0.10 | 0.34 ± 0.13 |
| Conductivity | | (0.36-0.49) | (0.04-0.19) | (0.19-0.51) |
| @25° C. | | | | |
| (range) | | | | |

^{a}Average of 6 samples.
^{b}Average of 5 samples.
^{c}Average of 7 samples.

### Example 20

A thermally conductive boron nitride non-single crystal, non-flake type filler (103.94 parts) (having an average particle size of 60 microns obtained from GE Advanced Ceramics) was mixed in a lab scale Ross mixer (1 quart capacity) at approximately 60 rpm with 100 parts of vinyl-stopped polydimethylsiloxane fluid (350-450 cSt, approximately 0.48 weight percent vinyl) at 25-35° C., and atmospheric pressure until a smooth consistency was obtained. To this mixture was added 0.21 parts of a pigment masterbatch (50 weight percent carbon black and 50 weight percent of a 10,000 cSt vinyl-stopped polydimethylsiloxane fluid) and a portion of the hydride fluid was added (0.66 parts of hydride functionalized polyorganosiloxane fluid, approximately 0.82 weight percent hydride.) The formulation was mixed at approximately 60 rpm for 6 minutes to incorporate the fluids and pigment. The temperature was then raised to 140-160° C. and the mixture was stirred at approximately 60 rpm for an additional 1.5 hours. The formulation was cooled to approximately 30° C. and the following materials were added: 0.16 parts triallyl isocyanurate, 0.02 parts 2-methyl-3-butyn-2-ol, and 0.03 parts of a tetramethyltetravinylcyclotetrasiloxane-complexed platinum catalyst (GE Silicones, 88346). The materials were incorporated by stirring for 8 minutes at approximately 60 rpm.

Additional materials were then added to the mixer: 0.92 parts of a first silane adhesion promoter (YC9632 from GE Toshiba), 0.60 parts of a second adhesion promoter (glycidoxypropyltrimethoxysilane), and the second portion of the hydride fluid was added (1.34 parts of hydride functionalized polyorganosiloxane fluid, approximately 0.82 weight percent hydride.) The additional materials were incorporated by stirring for 5 minutes at approximately 60 rpm. The final formulation was mixed for an additional 3 minutes at approximately 60 rpm and at a vacuum pressure of 25-30 inches Hg. The formulation was removed from the mixer and stored in a refrigerator (−40 to 0° C.) until needed to form a TIM.

To form the TIM Sandwich, the mixture was interposed between AlCr and Si coupons and cured under 10 psi pressure. Prior to dispensing the material from a syringe to place the TIM between the two coupons, the material was filtered through a 100 mesh filter screen to remove any foreign contaminants and then placed under vacuum for 3 minutes at 25-30 inches Hg to remove any residual entrapped air. The diffusivity and in-situ thermal conductivity of the resulting sandwiched structure was then determined by laser flash (Netzsch Instrument, Nanoflash LFA447.) The in-situ thermal resistance was determined by dividing the TIM bondline thickness by the TIM in-situ thermal conductivity. A total of 7 samples were prepared utilizing the formulation between the AlCr and Si coupons.

### Comparative Example 5

A formulation was prepared as described above in Example 20, except that a boron nitride powder (non-single crystal, non-flake-type, having a similar particle shape to the boron nitride powder used in Example 20) with an average particle size of 150 microns (PT350 from GE Advanced Ceramics) was used. The in-situ thermal performance of the formulation was determined as outlined in Example 20. A total of 5 samples were prepared utilizing the formulation between the AlCr and Si coupons.

Table 12 shows the average in-situ thermal resistances and bond line thicknesses for Example 20 and Comparative Example 5. It is evident from the table that formulations containing larger particles led to thicker bond lines and higher thermal resistances (poorer thermal performance).

TABLE 12

| | | Example | |
|---|---|---|---|
| | | 20^{a} | Comparative 5^{b} |
| Sandwich Material = | | AlCr-TIM-Si | AlCr-TIM-Si |
| Assembly Pressure | psi | 20 psi | 20 psi |
| Cure Pressure | psi | 10 psi | 10 psi |
| Bondline Thickness (range) | mil | 2.80 ± 0.12 | 3.72 ± 0.48 |
| | | (2.56-2.97) | (3.39-4.57) |
| In-situ Thermal Resistivity | mm²-K/W | 40 ± 2 | 88 ± 7 |
| @25° C. (range) | | (36-42) | (81-97) |
| In-situ Thermal | W/m-K | 1.80 ± 0.12 | 1.07 ± 0.11 |
| Conductivity @25° C. | | (1.65-2.01) | (0.93-1.22) |
| (range) | | | |

^{a}Average of 7 samples.
^{b}Average of 5 samples.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A thermal interface composition comprising a blend of a polymer matrix and a filler selected from the group consisting of metals, metal oxides, metal nitrides, and combinations thereof, wherein the filler possesses particles having a maximum particle diameter less than about 25 microns and the thermal interface composition possesses a bond line thickness of from about 0.01 mil to about 5 mil.

2. A thermal interface composition as in claim 1, wherein the polymer matrix comprises a curable polymeric composition.

3. A thermal interface composition as in claim 2, wherein the curable polymeric composition is selected from the group consisting of polydimethylsiloxane resins, epoxy resins, acrylate resins, organopolysiloxane resins, polyimide resins, polyimide resins, fluorocarbon resins, benzocyclobutene resins, and fluorinated polyallyl ethers, polyamide resins, polyimidoamide resins, cyanate ester resins, phenol resol resins, aromatic polyester resins, polyphenylene ether resins, bismaleimide triazine resins, fluororesins, combinations thereof, and any other polymeric systems known to those skilled in the art.

4. A thermal interface composition as in claim 2, wherein the curable polymeric composition comprises an organopolysiloxane having an average of at least two silicon-bonded alkenyl groups per molecule, an organohydrogenpolysiloxane containing at least two silicone-bonded hydrogen atoms per molecule and a suitable hydrosilylation catalyst.

5. A thermal interface composition as in claim 1, wherein the filler comprises aluminum.

6. A thermal interface composition as in claim 1, wherein the filler comprises a mixture of aluminum and alumina.

7. A thermal interface composition as in claim 6, wherein the ratio of aluminum to alumina ranges from about 1:10 by volume to about 10:1 by volume.

8. A thermal interface composition as in claim 1, wherein the filler comprises boron nitride.

9. A thermal interface composition as in claim 1, wherein the thermal interface composition possesses a bond line thickness of from about 0.02 mil to about 3.2 mil.

10. A thermal interface composition as in claim 1 further comprising an adhesion promoter.

11. A thermal interface composition as in claim 10 wherein the adhesion promoter is selected from the group consisting of alkoxysilanes, aryloxysilanes, silanols, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group, titanates, trialkoxy aluminum, tetraalkoxysilanes, isocyanurates, and mixtures thereof.

12. A thermal interface composition as in claim 1 further comprising a catalyst inhibitor.

13. A thermal interface composition as in claim 12 wherein the catalyst inhibitor is selected from the group consisting of phosphines, phosphites, sulfur compounds, amines, isocyanurates, alkynyl alcohols, maleate esters, fumarate esters, and mixtures thereof.

14. A thermal interface composition as in claim 1 possessing an in-situ thermal resistance ranging from about 0.01 to about 80 mm²-C/W.

15. A thermal interface composition comprising a blend of a curable polymer matrix comprising an organopolysiloxane having an average of at least two silicon-bonded alkenyl groups per molecule and an organohydrogenpolysiloxane containing at least two silicone-bonded hydrogen atoms per molecule, a suitable hydrosilylation catalyst and a filler selected from the group consisting of metals, metal oxides, metal nitrides, and combinations thereof, wherein the filler possesses particles having a maximum particle diameter less than 25 microns and the thermal interface composition possesses a bond line thickness of from about 0.01 mil to about 5 mil.

16. A thermal interface composition as in claim 15, wherein the filler comprises aluminum.

17. A thermal interface composition as in claim 15, wherein the filler comprises a mixture of aluminum and alumina.

18. A thermal interface composition as in claim 17, wherein the ratio of aluminum to alumina ranges from about 1:10 by volume to about 10:1 by volume.

19. A thermal interface composition as in claim 15, wherein the filler comprises boron nitride.

20. A thermal interface composition as in claim 15, wherein the thermal interface composition possesses a bond line thickness of from about 0.02 mil to about 3.2 mil.

21. A thermal interface composition as in claim 15 further comprising an adhesion promoter.

22. A thermal interface composition as in claim 21 wherein the adhesion promoter is selected from the group consisting of alkoxysilanes, aryloxysilanes, silanols, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group, titanates, trialkoxy aluminum, tetraalkoxysilanes, isocyanurates, and mixtures thereof.

23. A thermal interface composition as in claim 15 further comprising a catalyst inhibitor.

24. A thermal interface composition as in claim 23 wherein the catalyst inhibitor is selected from the group consisting of phosphines, phosphites, sulfur compounds, amines, isocyanurates, alkynyl alcohols, maleate esters, fumarate esters, and mixtures thereof.

25. A thermal interface composition as in claim 15 wherein the molar ratio of Si—H to alkenyl ranges from about 0.5 to about 5.0.

26. A thermal interface composition as in claim 15 wherein the molar ratio of Si—H to alkenyl ranges from about 0.8 to about 2.0.

27. A thermal interface composition as in claim 15 possessing an in-situ thermal resistance ranging from about 0.01 to about 80 mm²-C/W.

28. A method of increasing heat transfer comprising:
positioning a heat producing component in contact with a thermal interface composition comprising a blend of a polymer matrix and a filler selected from the group consisting of metals, metal oxides, metal nitrides, and combinations thereof, wherein the filler possesses particles having a maximum particle diameter less than about 25 microns and the thermal interface composition possesses a bond line thickness of from about 0.01 mil to about 5 mil; and
positioning a heat dissipating unit in contact with the thermal interface composition.

29. A method as in claim 28 wherein the step of positioning the heat producing component in contact with a thermal interface composition comprises utilizing a thermal interface composition possessing a bond line thickness of from about 0.02 mil to about 3.2 mil.

30. A method as in claim 28 wherein the step of positioning the heat dissipating unit in contact with a thermal interface composition comprises positioning a heat dissipating unit selected from the group consisting of heat spreaders, heat sinks, lids, heat pipes, and other devices known to those skilled in the art.

31. A method as in claim 28 wherein the step of positioning the heat producing component in contact with a thermal interface composition comprises positioning a heat producing component in contact with a blend of a curable polymer matrix and a filler comprising aluminum.

32. A method as in claim 28 wherein the step of positioning the heat producing component in contact with a thermal interface composition comprises positioning a heat producing component in contact with a blend of a curable polymer matrix and a filler comprising a mixture of aluminum and alumina.

33. A method as in claim 28 wherein the step of positioning the heat producing component in contact with a thermal interface composition comprises positioning a heat producing component in contact with a blend of a curable polymer matrix and a filler comprising boron nitride.

34. A method as in claim 28 wherein the step of positioning the heat producing component in contact with a thermal interface composition comprises positioning a heat producing component in contact with a blend of an organopolysiloxane having an average of at least two silicon-bonded alkenyl groups per molecule, an organohydrogenpolysiloxane containing at least two silicone-bonded hydrogen atoms per molecule, and a filler comprising aluminum.

35. A method as in claim 28 wherein the step of positioning the heat producing component in contact with a thermal interface composition comprises positioning a heat producing component in contact with a blend of an organopolysiloxane having an average of at least two silicon-bonded alkenyl groups per molecule, an organohydrogenpolysiloxane containing at least two silicone-bonded hydrogen atoms per molecule, and a filler comprising a mixture of aluminum and alumina.

36. A method as in claim 28 wherein the step of positioning the heat producing component in contact with a thermal interface composition comprises positioning a heat producing component in contact with a blend of an organopolysiloxane having an average of at least two silicon-bonded alkenyl groups per molecule, an organohydrogenpolysiloxane containing at least two silicone-bonded hydrogen atoms per molecule, and a filler comprising boron nitride.

37. A method as in claim 28 wherein the steps of positioning the heat dissipating unit in contact with the thermal interface composition further comprises controlling the bond line thickness of the thermal interface composition by an additional step selected from the group consisting of applying pressure, adjusting viscosity of the thermal interface composition, and subjecting the filler to ball-milling.

38. A method as in claim 28 wherein the step of positioning the heat producing component in contact with a thermal interface composition comprises applying pressure to the thermal interface composition so that the thermal interface composition possesses a bond line thickness of from about 0.02 mil to about 3.2 mil.

39. A method as in claim 28 further comprising the step of curing the thermal interface composition.

40. A method as in claim 39 wherein the step of curing the thermal interface composition comprises adding a catalyst.

41. A method as in claim 39 wherein the step of curing the thermal interface composition comprises adding a platinum catalyst.

42. A method as in claim 39 wherein the step of curing the thermal interface composition further comprises adding a catalyst inhibitor selected from the group consisting of phosphines, phosphites, sulfur compounds, amines, isocyanurates, alkynyl alcohols, maleate esters, fumarate esters, and mixtures thereof.

43. A method as in claim 28 wherein the step of positioning the heat producing component in contact with a thermal interface composition comprises adding to the thermal interface composition an adhesion promoter selected from the group consisting of alkoxysilanes, aryloxysilanes, silanols, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group, titanates, trialkoxy aluminum, tetraalkoxysilanes, isocyanurates, and mixtures thereof.

44. A method as in claim 28 wherein the step of positioning the heat producing component in contact with a thermal interface composition produces a thermal interface composition possessing an in-situ thermal resistance ranging from about 0.01 to about 80 mm²-C/W.

45. A method as in claim 28 wherein the step of positioning the heat producing component in contact with a thermal interface composition further comprises positioning a thermal interface composition selected from the group consisting of pre-formed sheets, films, greases and phase change materials in contact with the heat producing component.

46. An electronic component comprising:
a heat producing component;
a heat dissipating unit; and
a thermal interface composition interposed between the heat producing component and the heat dissipating unit, the thermal interface composition comprising a blend of a polymer matrix and a filler a filler selected from the group consisting of metals, metal oxides, metal nitrides, and combinations thereof, wherein the filler possesses particles having a maximum particle diameter less than about 25 microns and the thermal interface composition possesses a bond line thickness of from about 0.01 mil to about 5 mil.

47. An electronic component as in claim 46, wherein the heat producing component is a semiconductor chip.

48. An electronic component as in claim 46, wherein the polymer matrix comprises a curable polymer.

49. An electronic component as in claim 46, wherein the polymer matrix is selected from the group consisting of polydimethylsiloxane resins, epoxy resins, acrylate resins, organopolysiloxane resins, polyimide resins, fluorocarbon resins, benzocyclobutene resins, fluorinated polyallyl ethers, polyamide resins, acrylic resins, polyimidoamide resins, phenol resol resins, aromatic polyester resins, polyphenylene ether resins, bismaleimide triazine resins, fluororesins, combinations thereof and any other polymeric systems known to there skilled in the art.

50. An electronic component as in claim 46, wherein the curable polymeric composition comprises an organopolysiloxane having an average of at least two silicon-bonded alkenyl groups per molecule, an organohydrogenpolysiloxane containing at least two silicone-bonded hydrogen atoms per molecule and a suitable catalyst.

51. An electronic component as in claim 46, wherein the filler comprises aluminum.

52. An electronic component as in claim 46, wherein the filler comprises a mixture of aluminum and alumina.

53. An electronic component as in claim 52, wherein the ratio of aluminum to alumina ranges from about 1:10 by volume to about 10:1 by volume.

54. An electronic component as in claim 46, wherein the filler comprises boron nitride.

55. An electronic component as in claim 46, wherein the thermal interface composition possesses a bond line thickness of from about 0.02 mil to about 3.2 mil.

56. An electronic component as in claim 46, wherein the curable polymeric composition comprises a blend of an organopolysiloxane having an average of at least two silicon-bonded alkenyl groups per molecule and an organohydrogenpolysiloxane containing at least two silicone-bonded hydrogen atoms per molecule and the filler comprises a mixture of aluminum and alumina.

57. An electronic component as in claim 46, wherein the curable polymeric composition comprises a blend of an organopolysiloxane having an average of at least two silicon-bonded alkenyl groups per molecule and an organohydrogenpolysiloxane containing at least two silicone-bonded hydrogen atoms per molecule and the filler comprises boron nitride.

58. An electronic component as in claim 46 further comprising an adhesion promoter.

59. An electronic component as in claim 58 wherein the adhesion promoter is selected from the group consisting of alkoxysilanes, aryloxysilanes, silanols, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group, titanates, trialkoxy aluminum, tetraalkoxysilanes, isocyanurates, and mixtures thereof.

60. An electronic component as in claim 46 further comprising a catalyst inhibitor.

61. An electronic component as in claim 60 wherein the catalyst inhibitor is selected from the group consisting of phosphines, phosphites, sulfur compounds, amines, isocyanurates, alkynyl alcohols, maleate esters, fumarate esters, and mixtures thereof.

62. An electronic component as in claim 46, wherein the thermal interface composition possesses a thermal resistance ranging from about 0.01 to about 80 mm²-C/W.

63. An electronic component as in claim 46, wherein the thermal interface composition is a pre-applied material selected from the group consisting of pads, films, greases and phase change materials.
